(19) United States
(12) Patent Application Publication
(10) Pub. No.: US 2009/0296220 A1
(43) Pub. Date: Dec. 3, 2009

(54) APPARATUS USED TO IMPROVE AN USER'S ABILITY TO VIEW A BACK LIT SCREEN AND METHOD FOR ITS USE

(76) Inventor: Humberto G. Aguilera, Stanwood, WA (US)

Correspondence Address: Karr Tuttle Campbell;ATTN: PRIYA SINHA CLOUTIER, 1201 Third Ave., Ste 2900, Seattle, WA, 98101, US

(21) Appl. No.: 12/509,216

(22) Filed: Jul. 24, 2009

Related U.S. Application Data
(63) Continuation of application No. 11/243,420, filed on Oct. 5, 2005, now abandoned.

(51) Int. Cl. G02B 27/00

(52) U.S. Cl. 359/601

(57) ABSTRACT

The current invention is related to an apparatus used to improve the user's ability to view electronic back lit screens, such as but not limited to LCD, TFT, and Plasma screens, in brightly lit environment.

### CROSS-REFERENCES TO RELATED APPLICATIONS

This Application is a continuation of U.S. application Ser. No. 11/243,420 filed on 05 Oct. 2005, claims priority to that application, and incorporates that application in its entirety herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

The current invention is related to an apparatus used to improve the user's ability to view electronic back lit screens, such as but not limited to LCD, TFT, and Plasma screens, in brightly lit environment.

In Guile et.al. (U.S. Pat. No. 5,905,546, May 18, 1999) a detachable and foldable visor for electronic back lit screens is taught. Although the screen is portable, it must be reassembled for use each time, taking away valuable work time. Wong (U.S. Pat. No. 5,988,823, Nov. 23, 1999) is similar to Guile. Although Wong claims that his hood is adjustable to different size back lit screens, the size of the back lit screen is limited by predetermined folds, which allow size adjustment. Wong's hood cannot be adjusted to electronic back lit screens having unusual dimensions. Similar to Guile, Wong's hood must be reassembled each time it is used, taking away valuable work time. Additionally, although both Guile and Wong are portable, they are bulky when folded. Both Guile and Wong require the hood or visor to be folded properly before it can be stowed. Finally, both Guile and Wong require the user to utilize all parts of the visor/hood when only a portion may be needed.

One purpose of the current invention is to provide an apparatus that can easily be adjusted to standard size electronic back lit screens and odd sized back lit screens. In the modern age, electronic back lit screen are used on computers, televisions, cell phone, and personnel digital assistants, amongst others.

Another purpose of the current invention is to provide an apparatus that can be easily and quickly attached onto an object which has an electronic back lit screen. A third purpose of the current invention is to provide and apparatus that allows the user to have privacy when using an electronic back lit screen. A fourth object of invention is to allow the user to use only the parts of the apparatus that he deems necessary. A final object of the current invention is to provide an apparatus that can be easily stowed.

### BRIEF SUMMARY OF THE INVENTION

The current invention is related to an apparatus used to improve the user's ability to view electronic back lit screens, such as but not limited to LCD, TFT, and Plasma screens, in brightly lit environment.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is an elevational view of the apparatus as it is being put on an electronic back lit screen;

FIG. 2 is a side view of the apparatus;

FIG. 3 is a bottom view of the apparatus showing how the apparatus fits together;

FIG. 4 is a top side view of the apparatus;

FIG. 5 is a front view of the apparatus with side panels in place;

FIG. 6 is an exploded view of the side panel attaching into place;

FIG. 7 is a front view of the apparatus with curtain.

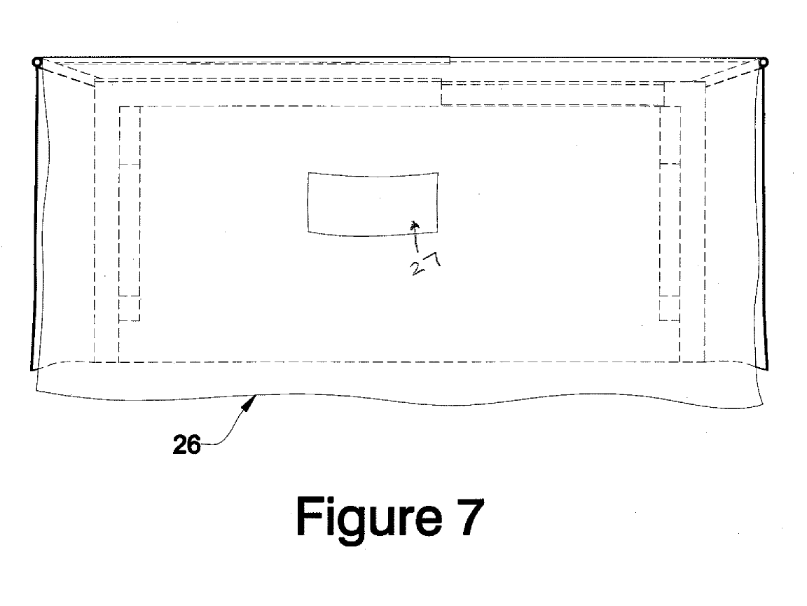

### DETAILED DESCRIPTION OF THE INVENTION

The present invention is described more fully hereinafter with reference to the accompanying drawings, in which preferred embodiments of the invention are shown. This invention may, however, be embodied in many different forms and should not be construed as limited to the embodiments set for herein; rather, these embodiments are provided so that this disclosure will be thorough and complete and will fully convey the scope of the invention to those skilled in the art.

With modern technology, users of computers (e.g. laptops, cell phones, personal digital assistance), have the ability to work anywhere. Being weary of the office environment, many computer users choose to sit in the sun and work. A brightly lit background prevents the user from seeing his electronic back lit screen. The user will have to adjust where he is sitting for optimal screen viewing. Consequently, the user may not be able to enjoy as much sun as he would have liked to. In another example, a television watcher may not be able to enjoy a great show because there is too much top lighting in his home or the drapes do not block all of the sun light. The current apparatus allows the user to enjoy his electronic device without such annoyances.

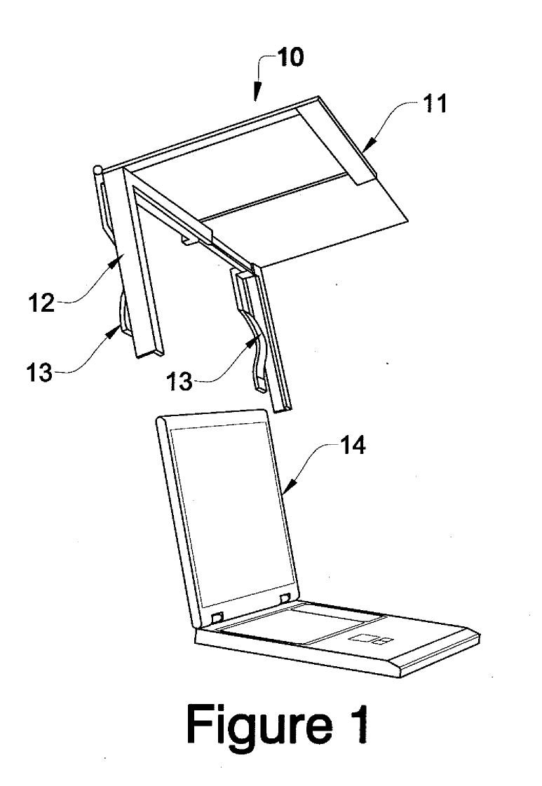

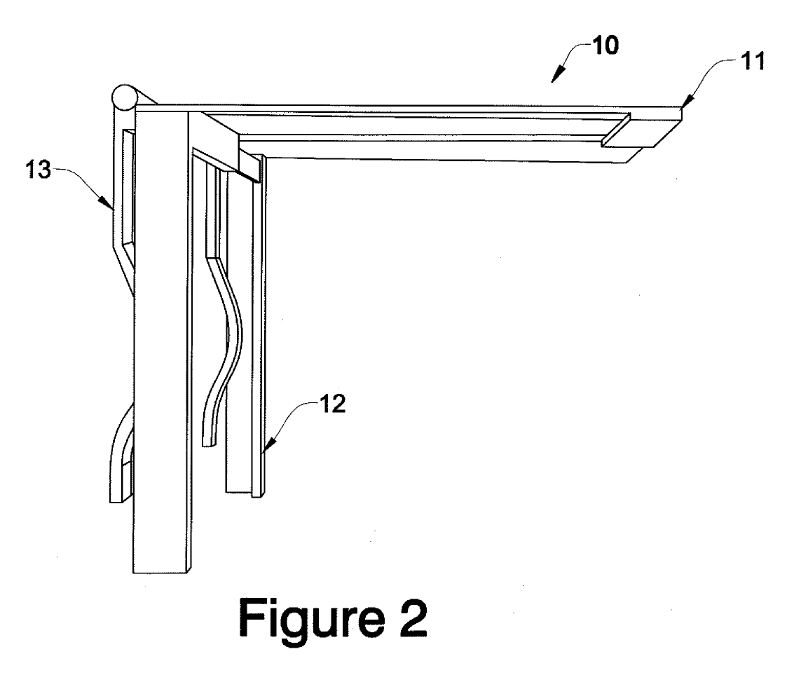

Referring to FIGS. 1 and 2, the current invention is an apparatus (10) that improves a user's ability to view electronic back lit screens (14), such as but not limited to LCD, TFT, and Plasma screens, in brightly lit environments. The apparatus (10) comprises a top flap (11) and a frame (12). In a preferred embodiment, the top flap (11) is pivotally attached to the frame (12). The frame (12) has a means to attach the apparatus to an electronic back lit screen (14). In the preferred embodiment, the means to attach the apparatus to an electronic back lit screen (14) is at least one clip (13). The at least one clip (13) slips over the electronic back lit screen (14) and secures the apparatus (10) into place.

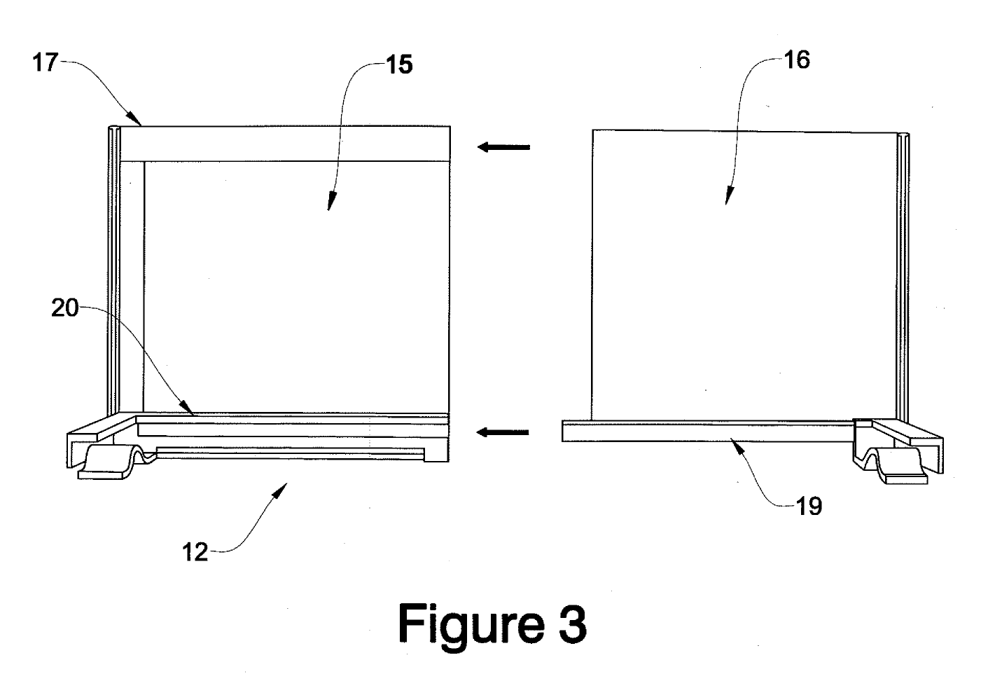

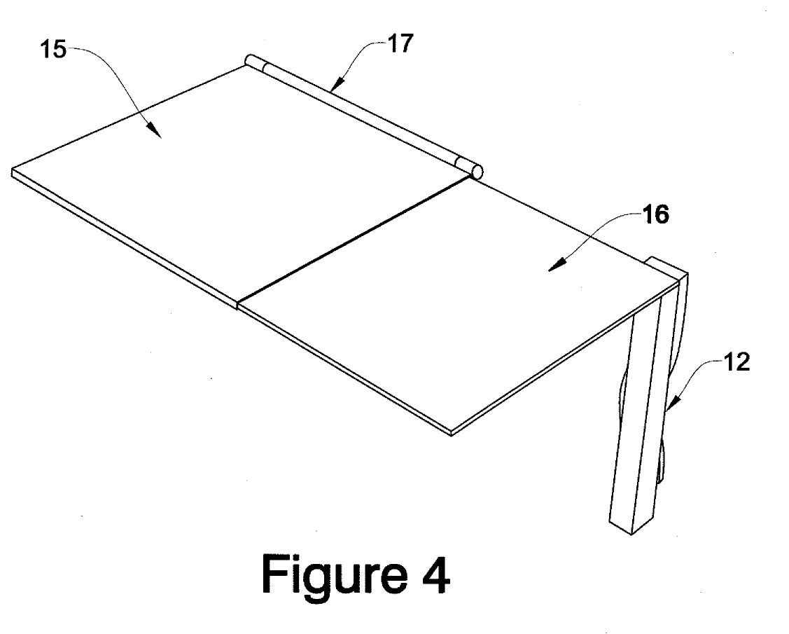

Referring to FIGS. 3 and 4, the top flap (11) comprises left panel (15), a right panel (16), and an outer frame (17). The outer frame (17) houses the left panel (15) and the right panel (16). The outer frame (17) allows the right panel (16) to telescope in order to adjust to the size of the electronic backlit screen (14). The frame (12) comprises a right side (19) and a left side (20). The right side (19) telescopes from the left side (20). The top flap (11) and the frame (12) are attached so that the top flap (11) and the frame (12) telescope at the same rate.

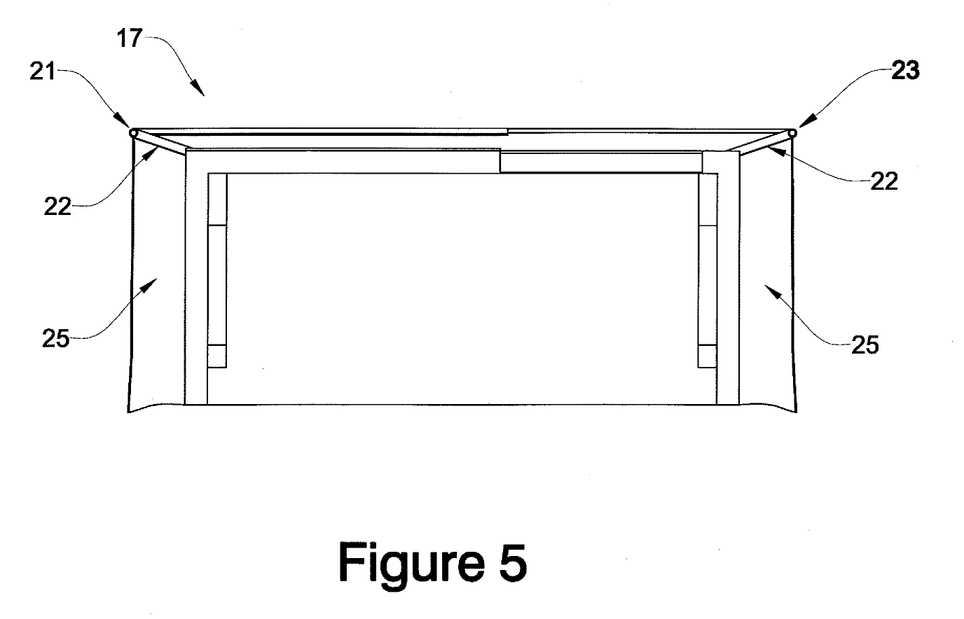

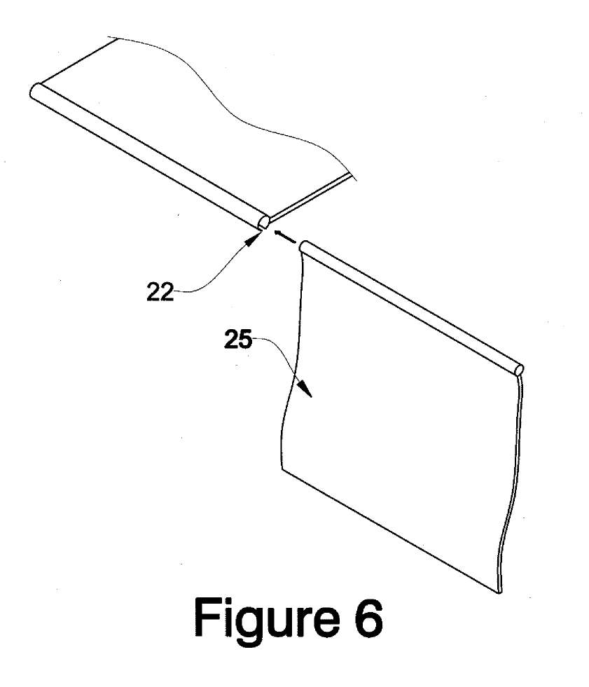

To obtain extra privacy or block unwanted light, the user can attach side panels to the apparatus (10). Referring to FIGS. 5 and 6, in a preferred embodiment, the outer frame (17) comprises a left outside (21). The left outside (21) defines a notch (22). The right panel (16) comprises right outside (23). The right outside (23) defines a notch (22). The left/right side panels (25) are slid into notches (22).

To obtain even more privacy or block a greater amount of light, the user can attach a curtain (26) to the apparatus (10). The curtain (26) defines a hole (27). In the preferred embodiment, the curtain (26) is attached to the left/right side panels (25) using VELCRO™. However, a person of ordinary skill in the art will know that the curtain (26) can be attached to the left/right side panels (25) using other attachments devices such as snaps, buttons, or zippers, amongst others.

1. An apparatus used to improve the user's ability to view an electronic back lit screen in a brightly lit environment; said apparatus comprises a top flap and frame.

2. The frame of claim 1 has a means to attach the apparatus to an electronic back lit screen.

3. The mean to attach the apparatus to an electronic back lit screen of claim 1 is a clip.

4. The top flap and frame of claim 1 are pivotally attached allowing rotation.

5. The top flap and frame of claim 1 are attached.

6. The top flap of claim 2 comprises a left panel, a right panel and an outer frame; said outer frame houses the left panel and the right panel allowing the right panel to telescope.

7. The frame of claim 2 comprises a right side and a left side; said right side telescopes from said left side.

8. The outer frame of claim 6 comprises a left outside; said left outside defines a notch.

9. The right panel of claim 6 comprises right outside; said right outside defines a notch.

10. The apparatus of claim 1 further comprises a left side panel and a right side panel; said right and left side panels slide into the notches of claim 8 and claim 9.

11. The apparatus of claim 10 further comprises a curtain; said curtain defines a hole.

12. The curtain of claim 11 is has a means to attach the curtain to the left/right side panels of claim 10.

13. The means to attach the curtain to the left/right side panels of claim 12 is VELCRO™.

14. A method to use the apparatus of claim 1 comprises attaching the apparatus of claim 1 to the electronic back lit screen.
